(19) United States
(12) Patent Application Publication
(10) Pub. No.: US 2026/0288337 A1
(43) Pub. Date: Sep. 24, 2026

(54) DATA ACCESS DEVICE FOR SRAM ARRAY, SYSTEM, METHOD, APPARATUS, CHIP AND MEDIUM

(71) Applicant: Shenzhen MicroBT Electronics Technology Co., Ltd., Nanshan District Shenzhen, Guangdong (CN)

(72) Inventors: Yongzhi LV, Nanshan District Shenzhen, Guangdong (CN); Zhijun FAN, Nanshan District Shenzhen, Guangdong (CN); Jianneng SHOU, Nanshan District Shenzhen, Guangdong (CN); Zuoxing YANG, Nanshan District Shenzhen, Guangdong (CN)

(73) Assignee: Shenzhen MicroBT Electronics Technology Co., Ltd., Nanshan District Shenzhen, Guangdong (CN)

(21) Appl. No.: 18/996,095

(22) PCT Filed: Aug. 20, 2024
(86) PCT No.: PCT/CN2024/113259

§ 371 Date: Jan. 17, 2025

(30) Foreign Application Priority Data
Sep. 5, 2023 (CN) 202311133321.4

(51) Int. Cl. G06F 3/06

(52) U.S. Cl. CPC G06F 3/0613; G06F 3/0659; G06F 3/0673

(57) ABSTRACT

Disclosed are a data access device for an SRAM array, system, method, apparatus, chip and medium. The device includes: M arbitration modules, each of which is coupled with one of M SRAM groups; and a parsing module, coupled with the M arbitration modules and configured to receive N data access requests in parallel, parse at least one access command from each of the N data access requests, each access command being a read command or a write command and directed to one SRAM group, and send the respective access command to the arbitration module coupled with the SRAM group to which the respective access command is directed, wherein each of the M arbitration modules is configured to: in response to a determination of receiving one access command directed to the respective SRAM group, send the one access command directed to the respective SRAM group to the respective SRAM group, so that the one access command is executed by the respective SRAM group, wherein M is a positive integer greater than or equal to 2 and N is a positive integer. Access a plurality of SRAM groups in parallel to improve access efficiency and solve an access conflict problem.

The present application claims priority to Chinese Patent Application No. 202311133321.4, entitled “Data Access Device for SRAM Array, System, Method, Apparatus, Chip and Medium”, filed on Sep. 5, 2023, with China National Intellectual Property Administration, the entire contents of which are incorporated herein by reference.

### TECHNICAL FIELD

The disclosure relates to the field of data storage, and, in particular, to a data access device for a Static Random-Access Memory (SRAM) array, system, method, apparatus, chip and medium.

### BACKGROUND ART

An SRAM is a common memory device in chip design. Due to limitation in an SRAM manufacturing process, the capacity of a single SRAM is usually limited. A System on Chip (SOC) has a large demand for SRAM space, and usually uses an SRAM array containing a plurality of groups of SRAMs to realize large space storage.

At present, for an SRAM array containing a plurality of groups of SRAMs, when accessing one group of SRAMs in the SRAM array, the other SRAM groups are idle and inaccessible (unreadable and unwritable), resulting in low access efficiency.

### SUMMARY OF THE INVENTION

Embodiments of the disclosure provide a data selection device for an SRAM array, a storage system and a system on a chip.

Technical solutions of the embodiments of the disclosure are as follows.

A data access device for an SRAM array including M SRAM groups includes:

M arbitration modules, each of which is coupled with one of the M SRAM groups; and
a parsing module, coupled with the M arbitration modules and configured to receive N data access requests in parallel, parse at least one access command from each of the N data access requests, each access command being a read command or a write command and directed to one SRAM group, and send the respective access command to the arbitration module coupled with the SRAM group to which the respective access command is directed;
wherein each of the M arbitration modules is configured to: in response to a determination of receiving one access command directed to the respective SRAM group, send the one access command directed to the respective SRAM group to the respective SRAM group, so that the one access command is executed by the respective SRAM group, and
wherein M is a positive integer greater than or equal to 2 and N is a positive integer.

A data access system for an SRAM array includes:
an SRAM array including a plurality of SRAM groups, each SRAM group including a plurality of SRAMs;
M arbitration modules, each of which is coupled with one of the M SRAM groups; and
a parsing module, coupled with the M arbitration modules and configured to receive N data access requests in parallel, parse at least one access command from each of the N data access requests, each access command being a read command or a write command and directed to one SRAM group, and send the respective access command to the arbitration module coupled with the SRAM group to which the respective access command is directed,
wherein each of the M arbitration modules is configured to: in response to a determination of receiving one access command directed to the respective SRAM group, send the one access command directed to the respective SRAM group to the respective SRAM group, so that the one access command is executed by the respective SRAM group, and
wherein M is a positive integer greater than or equal to 2 and N is a positive integer.

A system on a chip includes the above data access device for an SRAM array or the above data access system for an SRAM array.

A data access method for an SRAM array including M SRAM groups includes:
receiving N data access requests;
parsing at least one access command from each of the N data access requests, each access command being a read command or a write command and directed to one SRAM group; and
for each SRAM group, performing arbitration processing comprising: in response to a determination of receiving one access command directed to the respective SRAM group, sending the one access command to the respective SRAM group, so that the one access command is executed by the respective SRAM group, wherein M is a positive integer greater than or equal to 2 and N is a positive integer.

An electronic apparatus includes:
a memory; and
a processor,
wherein the memory has stored therein an application program executable by the processor to cause the processor to execute the above data access method for an SRAM array.

A computer-readable storage medium has stored thereon computer-readable instructions, which, when executed by a processor, cause the processor to execute the above data access method for an SRAM array.

As can be seen from the above technical solutions, in the embodiments of the disclosure, a plurality of data access requests are received in parallel, and each of the data access requests is parsed to send access commands to arbitration modules coupled with the SRAM groups to which the access commands are directed, respectively, so that parallel processing of the plurality of data access requests can be implemented, a plurality of SRAM groups can be accessed in parallel, the access efficiency of the SRAM array can be improved, and a conflict problem that a read command and a write command access a same SRAM group at the same time can be solved based on the arbitration modules.

### BRIEF DESCRIPTION OF THE DRAWINGS

FIG. 1 is a schematic diagram of accessing an SRAM array in the related art.

FIG. 2 is a diagram illustrating an exemplary structure of a data access device for an SRAM array according to an embodiment of the disclosure.

FIG. 3 is a diagram illustrating an exemplary structure of input and output ports of an arbitration module according to an embodiment of the disclosure.

FIG. 4 is a diagram illustrating an exemplary structure of a data access method for an SRAM array according to an embodiment of the disclosure.

FIG. 5 is a diagram illustrating an exemplary structure of an electronic apparatus according to an embodiment of the disclosure.

### DETAILED DESCRIPTION OF EMBODIMENTS

The disclosure is hereinafter described in detail with reference to the accompanying drawings to further clarify the objects, technical solutions and advantages of the present disclosure.

Hereinafter, solutions of the disclosure are described by describing several representative embodiments therein for conciseness and intuition in description. A large number of details in the embodiment are only used to help understand the solutions of the disclosure. However, obviously, the technical solutions of the disclosure may be implemented without being limited to these details. Some embodiments are not described in detail, but only a framework is given, in order to avoid unnecessarily obscuring a solution of the disclosure. Hereinafter, “including” means “including but being not limited to” and “according to” means “at least according to, but not only according to”. Due to the language habit of Chinese, when the number of a component is not specified hereinafter, it means that the number of the component may be one or more, or may be understood as at least one.

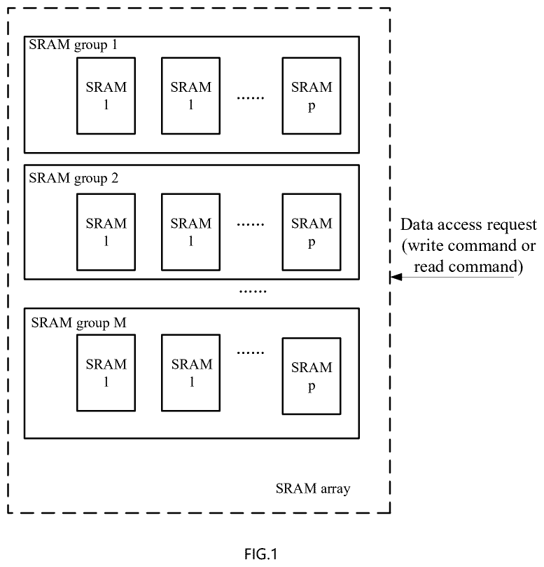

FIG. 1 is a schematic diagram of accessing an SRAM array in the related art. An SRAM arrays usually contain a plurality of SRAM groups, and each SRAM group contains a plurality of SRAMs. The SRAM array shown in FIG. 1 includes M SRAM groups, SRAM group 1, SRAM group 2, SRAM group 3, . . . , and SRAM group M. Each SRAM group contains p SRAMs. Therefore, the SRAM array contains M*p SRAMs in total, where M is a positive integer greater than or equal to 2, and p is a positive integer.

In some embodiments, an SRAM group is the access object of a data access request in technical practice. At the same time, the SRAM array can only process one data access request (the data access request contains a read command or a write command, but can not contain both a read command and a write command at the same time), and based on this data access request, only one SRAM group in the SRAM array is accessed, while the other SRAM groups cannot be accessed at the same time.

For example, suppose that a data access party (for example, a host) needs to read data from SRAM group 1 in an SRAM array, and the data access party sends a read command with the destination address of SRAM group 1 to the SRAM array. In response to the read command, the SRAM array returns the data in SRAM group 1 to the data access party. However, when it is necessary to simultaneously (i.e., in parallel) access at least two SRAM groups in the SRAM array (for example, requesting to read data from SRAM group 1 and write data to SRAM group 2 in parallel), the related art cannot access the plurality of SRAM groups in parallel.

In order to solve the above problem, the applicant considers sending a read command with the destination address of SRAM group 1 and a write command with the destination address of SRAM group 2 to the SRAM array in parallel. However, the applicant further found that since there is no corresponding mechanism in the SRAM array to cooperatively process a plurality of parallel data access requests, this simple solution of sending a plurality of data access requests to the SRAM array in parallel cannot implement access to a plurality of SRAM groups in parallel.

An embodiment of the disclosure provides a data access technical solution for an SRAM array, which receives a plurality of data access requests, and parses each data access request to send access commands to arbitration modules coupled with SRAM groups to which the access commands are directed, respectively, thereby realizing parallel processing for the plurality of data access requests, accessing a plurality of SRAM groups in parallel and improving access efficiency of the SRAM array.

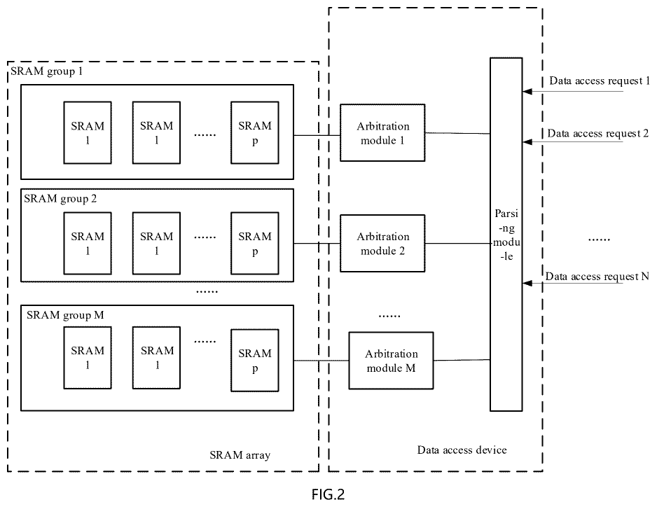

FIG. 2 is a diagram illustrating an exemplary structure of a data access device for an SRAM array according to an embodiment of the disclosure. The SRAM array shown in FIG. 2 includes M SRAM groups, SRAM group 1, SRAM group 2, SRAM group 3, . . . , and SRAM group M. Each SRAM group contains p SRAMs. Therefore, the SRAM array contains M*p SRAMs in total. The data access device includes:
M arbitration modules corresponding to M SRAM groups, wherein each arbitration module is coupled with one of the M SRAM groups; and
a parsing module, coupled with the M arbitration modules and configured to receive N data access requests in parallel, parsing at least one access command from each of the N data access requests, each access command being a read command or a write command and directed to one SRAM group, and send the respective access command to the arbitration module coupled with the SRAM group to which the respective access command is directed.

Each of the M arbitration modules is configured to: in response to a determination of receiving one access command directed to the respective SRAM group, send the one access command directed to the respective SRAM group to the respective SRAM group, so that the one access command is executed by the respective SRAM group, wherein M is a positive integer greater than or equal to 2, and N is a positive integer greater than or equal to 1.

In an alternative embodiment, the M arbitration modules may be integrated into a whole arbitration unit, and the whole arbitration unit corresponds to the M SRAM groups, so as to integrally handle the access arbitration processing for the M SRAM groups. In another alternative embodiment, some of the M arbitration modules may be integrated into one or more arbitration units (the specific number may depend on a specific integration strategy), while the remaining arbitration modules keep functionally independent. At this time, the integrated one or more arbitration units integrally handle access arbitration processing of SRAM groups corresponding to the one or more arbitration units, while the remaining arbitration modules continue to independently handle the access arbitration processing of SRAM groups corresponding to the remaining arbitration modules.

As can be seen, the parallel processing of a plurality of data access requests is implemented, the plurality of SRAM groups can be accessed in parallel, and the access efficiency of the SRAM arrays can be improved.

In an embodiment, the parsing module may receive N data access requests in parallel from a full-duplex data transmission bus, wherein the full-duplex data transmission bus includes at least one of: AXI-Lite; AXI-Full; and AXI-Stream, wherein both the AXI-Lite and the AXI-Full implement data transmission based on memory mapping (i.e., including an address bus), while the AXI-Stream implements transmission in the form of a data stream without an address bus. The AXI-Lite is a simplified version of the AXI-Full, which is suitable for a small batch of data transmission and is often used for command transmission; and the AXI-Full is suitable for mass and high-performance data transmission.

Typical examples of full-duplex data transmission buses have been described exemplarily above, and those skilled in the art can realize that this description is only exemplary and is not used to limit embodiments of the disclosure.

In an embodiment, each data access request may include at least one access command. For example, a data access request may contain a write command and a read command at the same time, where the destination SRAM group of the write command and the destination SRAM group of the read command may be the same or different.

Example 1: data access request 1 in FIG. 2 may contain a write command and a read command at the same time, where the destination SRAM group of the write command is SRAM group 1, that is, the write command is directed to SRAM group 1, while the destination SRAM group of the read command is SRAM group 2, that is, the read command is directed to SRAM group 2. In other words, data access request 1 indicates to initiate a write operation on SRAM group 1 and a read operation on SRAM group 2.

Example 2: data access request 1 in FIG. 2 contains a write command and a read command at the same time, where the destination SRAM group of the write command is SRAM group 1, that is, the write command is directed to SRAM group 1, and the destination SRAM group of the read command is SRAM group 1, that is, the read command is directed to SRAM group 1. In other words, data access request 1 indicates to initiate a write operation on SRAM group 1 and a read operation on SRAM group 1. In this case, there are both a read command and a write command for a same SRAM group, which usually leads to a conflict problem, and the conflict problem may be solved by an arbitration mechanism of an arbitration module to be described in detail later.

In an embodiment, a data access request may contain only one of a write command or a read command.

Example 1: data access request 2 in FIG. 2 contains only a write command, where the destination SRAM group of the write command is SRAM group 1. That is, data access request 2 indicates to initiate a write operation on SRAM group 1.

Example 2: data access request 2 in FIG. 2 contains only a read command, where the destination SRAM group of the read command is SRAM group 2. That is, data access request 2 indicates to initiate a read operation on SRAM group 2.

The parsing module parses at least one access command from each data access request of N data access requests, each access command being a read command or a write command, and then sends the respective access command to an arbitration module coupled with the SRAM group to which the respective access command is directed.

For example, suppose that the parsing module receives four data access requests, namely data access request 1, data access request 2, data access request 3, and data access request 4, in total.

Data access request 1 contains: (1) write command 1 for SRAM group 1; and (2) read command 1 for SRAM group 2.

Data access request 2 contains: (1) write command 2 for SRAM group 3.

Data access request 3 contains: (1) write command 3 for SRAM group 4; and (2) read command 2 for SRAM group 5.

Data access request 4 contains: (1) write command 4 for SRAM group 6; and (2) read command 3 for SRAM group 7.

The parsing module: sends write command 1 (for SRAM group 1) to arbitration module 1 corresponding to SRAM group 1; sends read command 1 (for SRAM group 2) to arbitration module 2 corresponding to SRAM group 2; sends write command 2 (for SRAM group 3) to arbitration module 3 corresponding to SRAM group 3; sends write command 3 (for SRAM group 4) to arbitration module 4 corresponding to SRAM group 4; sends read command 2 (for SRAM group 5) to arbitration module 5 corresponding to SRAM group 5; sends write command 4 (for SRAM group 6) to arbitration module 6 corresponding to SRAM group 6; and, sends read command 3 (for SRAM group 7) to arbitration module 7 corresponding to SRAM group 7.

Each arbitration module from arbitration module 1 to arbitration module 7 determines that there is one received access command directed to a corresponding SRAM group. For example, it is determined that there are not a write command and a read command at the same time. Therefore, the respective write command or read command may be sent to the respective SRAM group, so that the plurality of commands can be executed in parallel by the plurality of SRAM groups. Specifically: SRAM group 1 executes write command 1; SRAM group 2 executes read command 1; SRAM group 3 executes write command 2; SRAM group 4 executes write command 3; SRAM group 5 executes read command 2; SRAM group 6 executes write command 4; and SRAM group 7 executes read command 3, thereby realizing parallel access to the 7 SRAM groups in the SRAM array.

In the above, an exemplary example in which the arbitration modules do not receive a read command and a write command from the parsing module at the same time is described. In fact, based on the specific configuration of a data access request, an arbitration module may also receive a read command and a write command from the parsing module at the same time, that is, there is a conflict between reading and writing.

In an embodiment, each arbitration module is configured to: in response to a determination of receiving at least two access commands directed to the respective SRAM group, determine an execution order of the at least two access commands based on a predetermined arbitration strategy, and send the at least two access commands to the respective SRAM group in sequence according to the execution order, so that the at least two access commands are executed by the respective SRAM group in sequence. For example, when it is determined that there are a read command for a corresponding SRAM group and a write command for a corresponding SRAM group at the same, the read command for a corresponding SRAM group and write command for a corresponding SRAM group are arbitrated based on the predetermined arbitration strategy to obtain an arbitration result indicating an execution order. Based on the arbitration result, an access command (e.g., the read command for a corresponding SRAM group or the write command for a corresponding SRAM group) is sent to the respective SRAM group first, so that the read command for a corresponding SRAM group or the write command for a corresponding SRAM group is executed by the respective SRAM group. Then, after execution of the one access command is completed, the arbitration module will send another access command to the respective SRAM group.

When the arbitration module receives two access commands such as a read command and a write command from the parsing module at the same time, an execution order may be determined based on the predetermined arbitration strategy. For example, a specific command to be executed preferentially is selected. As can be seen, an embodiment of the disclosure can perform arbitration based on the arbitration modules, and solves the conflict problem that a read command and a write command access a same SRAM group at the same time.

Usually, in order to ensure logical consistency, the arbitration strategies adopted in the respective arbitration modules are the same. However, the arbitration strategies adopted in the respective arbitration modules may also be different.

Preferably, the arbitration strategies include:
(1) a polling execution strategy;
(2) a read command priority strategy;
(3) a write command priority strategy; and
(4) a time division strategy.

In the polling execution strategy, read and write commands are executed by polling, that is, read and write commands are executed alternately. For example, when a read command and a write command are received at the same time for the first time, the execution order is: executing the write command first, and then executing the read command. When a read command and a write command are received at the same time for the second time, the execution order is: executing the read command first, and then executing the write command. When a read command and a write command are received at the same time for the third time, the execution order is: executing the write command first, and then executing the read command. When a read command and a write command are received at the same time for the fourth time, the execution order is: executing the read command first, and then executing the write command. For another example, when the arbitration module receives two access commands (including a read command and a write command) from the parsing module at the same time, if the respective SRAM group recently executed the read command (that is, the read command was executed last time), the execution order of the two access commands received this time is: executing the write command first, and then executing the read command. If the respective SRAM group recently executed the write command (that is, the write command was executed last time), the execution order of the two access commands received this time is: executing the read command first, and then executing the write command. In the read command priority strategy, a read command is executed first. In the write command priority strategy, a write command is executed first. In the time division strategy, a corresponding command is processed based on a time period. For example, only a read command is processed in an initial time period, while a write command is processed in the next time period; or, only a write command is processed in the initial period, while a read command is processed in the next period, and so on.

Typical examples of arbitration strategies have been described exemplarily above, and those skilled in the art can realize that this description is only exemplary and is not used to limit the protection scope of the embodiments of the disclosure.

For example, suppose that the parsing module receives four data access requests, namely data access request 1, data access request 2, data access request 3, and data access request 4, in total.

Data access request 1 contains: (1) write command 1 for SRAM group 1; and (2) read command 1 for SRAM group 2.

Data access request 2 contains: (1) read command 2 for SRAM group 1.

Data access request 3 contains: (1) write command 2 for SRAM group 4; and (2) read command 3 for SRAM group 5.

Data access request 4 contains: (1) write command 3 for SRAM group 6; and (2) read command 4 for SRAM group 7.

The parsing module: sends write command 1 and read command 2 (both for SRAM group 1) to arbitration module 1 corresponding to SRAM group 1; and, sends read command 1 (for SRAM group 2) to arbitration module 2 corresponding to SRAM group 2; sends write command 2 (for SRAM group 4) to the arbitration module 4 corresponding to SRAM group 4; sends read command 3 (for SRAM group 5) to arbitration module 5 corresponding to SRAM group 5; sends write command 3 (for SRAM group 6) to the arbitration module 6 corresponding to SRAM group 6; and, sends read command 4 (for SRAM group 7) to arbitration module 7 corresponding to SRAM group 7.

Each of arbitration module 2, arbitration module 4, arbitration module 5, arbitration module 6 and arbitration module 7 determines that there are not a write command and a read command at the same time (that is, a write command and a read command are not received at the same time, and only one access command is received), so each can execute the respective write command or read command, so as to access the 5 corresponding SRAM groups in the SRAM array in parallel.

Arbitration module 1 determines that there are both a write command and a read command (write command 1 and read command 2) at the same time, and performs arbitration based on a predetermined arbitration strategy (assuming the read command priority strategy). A result of the arbitration is that read command 2 is executed first to read data from SRAM group 1, and then write command 1 is executed to write data to SRAM group 1 after execution of read command 2 is completed. Therefore, arbitration module 1 sends read command 2 to SRAM group 1 first to read data from SRAM group 1, and then sends write command 1 to SRAM group 1 to write data to SRAM group 1.

In an embodiment, a read command includes a first group selection signal and a read control instruction. The first group selection signal is used for selecting a corresponding SRAM group in a read operation, and the read control instruction is used for reading data in the corresponding SRAM group. For example, the read control instruction may include: (1) an SRAM chip in SRAM group selection enable signal for selecting an SRAM from an SRAM group; (2) an SRAM read enable signal for enabling a read operation of an SRAM ; and (3) a read address in an SRAM.

In an embodiment, a write command includes a second group selection signal and a write control instruction. The second group selection signal is used for selecting a corresponding SRAM group in a write operation, and the write control instruction is used for writing data in the corresponding SRAM group. For example, the write control instruction may include: (1) an SRAM chip in SRAM group selection enable signal for selecting an SRAM from an SRAM group; (2) an SRAM write enable signal for enabling a write operation of an SRAM; and (3) a write address in an SRAM.

Based on the above specific command type, an embodiment of the disclosure also provides a structure of input/output ports of an arbitration module.

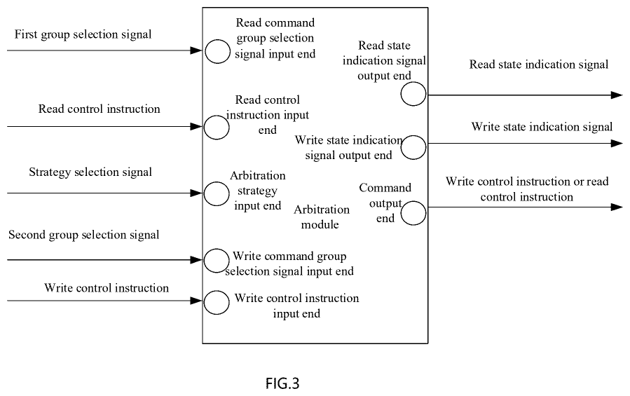

FIG. 3 is a diagram illustrating an exemplary structure of input and output ports of an arbitration module according to an embodiment of the disclosure.

As shown in FIG. 3, the input and output ports of the arbitration module include: a read command group selection signal input end for receiving a first group selection signal; a read control instruction input end for receiving a read control instruction; an arbitration strategy input end for receiving an arbitration strategy selection signal; a write command group selection signal input end for receiving a second group selection signal; a write control instruction input end for receiving a write control instruction; a command output end for sending a read control command or a write control command to a corresponding SRAM group; a read state indication signal output end for outputting a read state indication signal to a corresponding SRAM group; and a write state indication signal output end for outputting a write state indication signal to a corresponding SRAM group, wherein the read state indication signal is used to indicate whether the SRAM group is in a readable state, for example, when the read state indication signal is at a high level, it indicates that the SRAM group is in a readable state; the write state indication signal is used to indicate whether the SRAM group is in a writeable state, for example, when the write state indication signal is at a high level, it indicates that the SRAM group is in a writeable state.

The data access device and data access system for an SRAM array described above may be applied to a system on a chip. An embodiment of the disclosure also provides a system on a chip including any one of the aforementioned data access systems for an SRAM array or any one of the aforementioned data access devices for an SRAM array.

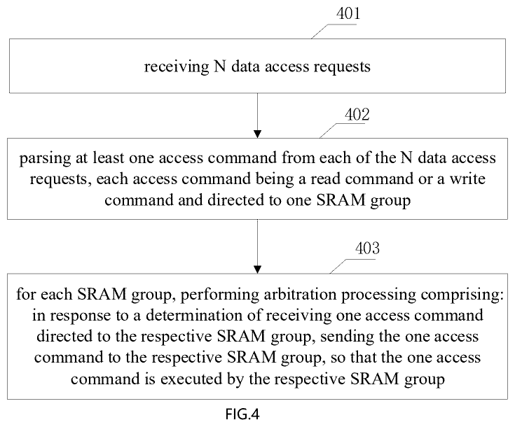

It is to be noted that according to embodiments of the disclosure, a service logic executed by the data access device can be implemented as a specific hardware circuit by using a hardware description language. For example, according to an embodiment of the disclosure, the data access chip (i.e., a hardware circuit structure of the data access device) may be implemented in a Field-Programmable Gate Array (FPGA) using a code of the business logic described by the Register Transfer Level (RTL). For another example, according to an embodiment of the disclosure, the code of the business logic described by the RTL may be implemented as an Application Specific Integrated Circuit (ASIC) chip (i.e., the hardware circuit structure of the data access device). As can be seen from the above, based on the business logic of the data access device described in the embodiments of FIGS. 2 and 3, those skilled in the art can undoubtedly implement a specific circuit structure of the data access device through the hardware description language. Therefore, the specific structure of the data access device in the embodiment of the disclosure can be implemented as an FPGA or ASIC chip. Accordingly, an arbitration module and a parsing module can be implemented as corresponding circuit structures in FPGA or ASIC. FIG. 4 is a diagram illustrating an exemplary structure of a data access method for an SRAM array according to an embodiment of the disclosure. As shown in FIG. 4, the method comprises the following steps.
Step 401: receiving N data access requests.
Step 402: parsing at least one access command from each of the N data access requests, each access command being a read command or a write command and directed to one SRAM group.
Step 403: for each SRAM group, performing arbitration processing comprising: in response to a determination of receiving one access command directed to the respective SRAM group, sending the one access command to the respective SRAM group, so that the one access command is executed by the respective SRAM group, wherein M is a positive integer greater than or equal to 2 and N is a positive integer.

In an embodiment, the data access method of the present application can be performed in an FPGA, an ASIC or an electronic apparatus.

In an embodiment, performing arbitration processing includes:
in response to a determination of receiving at least two access commands directed to the respective SRAM group, determining an execution order of the at least two access commands based on a predetermined arbitration strategy;
sending the at least two access commands to the respective SRAM group in sequence according to the execution order, so that the respective SRAM group executes the at least two access commands in sequence.

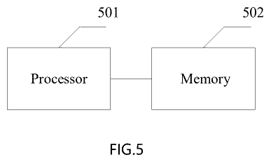

FIG. 5 is a diagram illustrating an exemplary structure of an electronic apparatus according to an embodiment of the disclosure. The electronic apparatus 500 includes a processor 501 and a memory 502. The processor 501 may include one or more processing cores, such as a 4-core processor, an 8-core processor, etc. The processor 501 can be implemented using at least one hardware form of Digital Signal Processing (DSP), Field-Programmable Gate Array (FPGA) and Programmable Logic Array (PLA). The processor 501 may also include a main processor and a co-processor, wherein the main processor is a processor for processing data in an awake state, and is also called a Central Processing Unit (CPU), and the co-processor is a low-power processor for processing data in a standby state. In some embodiments, the processor 501 may be integrated with a Graphics Processing Unit (GPU), and the GPU is used to render and draw the content to be displayed on a display screen. In some embodiments, the processor 501 may also include an AI processor, which is used to process computing operations related to machine learning. For example, the AI processor can be implemented as a neural network processor.

The memory 502 may include one or more computer-readable storage media, which may be non-transitory. The memory 502 may also include a high-speed random access memory, and a non-volatile memory, such as one or more magnetic disk storage apparatuses and flash memory storage apparatuses.

In some embodiments, the non-transitory computer-readable storage medium in the memory 502 is used to store at least one instruction, and at least one instruction is used to be executed by the processor 501 to implement the data access method for an SRAM array provided in various embodiments of the present disclosure.

The foregoing is only preferred embodiments of the present disclosure and is not for use in limiting the protection scope thereof. Any modification, equivalent substitution, and improvement without departing from the spirit and principle of the present disclosure should be covered in the protection scope of the present disclosure.

1-12. (canceled)

13. A data access device for an SRAM array, the SRAM array comprising M SRAM groups, the device comprising:
M arbitration modules, each of which is coupled with one of the M SRAM groups; and
a parsing module, coupled with the M arbitration modules and configured to receive N data access requests in parallel, parse at least one access command from each of the N data access requests, each access command being a read command or a write command and directed to one SRAM group, and send the respective access command to the arbitration module coupled with the SRAM group to which the respective access command is directed,
wherein each of the M arbitration modules is configured to: in response to a determination of receiving one access command directed to the respective SRAM group, send the one access command directed to the respective SRAM group to the respective SRAM group, so that the one access command is executed by the respective SRAM group,
wherein M is a positive integer greater than or equal to 2 and N is a positive integer.

14. The device of claim 13, wherein:
each of the arbitration modules is further configured to: in response to a determination of receiving at least two access commands directed to the respective SRAM group, determine an execution order of the at least two access commands based on a predetermined arbitration strategy, and send the at least two access commands to the respective SRAM group in sequence according to the execution order, so that the at least two access commands are executed by the respective SRAM group in sequence.

15. The device of claim 13, wherein the arbitration strategy comprises at least one of:
a polling execution strategy;
a read command priority strategy;
a write command priority strategy; and
a time division strategy.

16. The device of claim 13, wherein:
the parsing module is further configured to receive the N data access requests in parallel from a full-duplex data transmission bus, wherein the full-duplex data transmission bus comprises at least one of:
the Advanced Extensible Interface Protocol-simplified version; the Advanced Extensible Interface Protocol-Full Edition; and the Advanced Extensible Interface Protocol-Streaming Edition.

17. The method of claim 13, wherein:
the read command comprises a first group selection signal and a read control instruction, wherein the first group selection signal is used for selecting a corresponding SRAM group in a read operation, and the read control instruction is used for reading data in the corresponding SRAM group;
the write command comprises a second group selection signal and a write control instruction, wherein the second group selection signal is used for selecting a corresponding SRAM group in a write operation, and the write control instruction is used for writing data in the corresponding SRAM group;
the arbitration module comprises:
a read command group selection signal input end, configured to receive the first group selection signal;
a read control instruction input end, configured to receive the read control instruction;
an arbitration strategy input end, configured to receive an arbitration strategy selection signal;
a write command group selection signal input end, configured to receive the second group selection signal;
a write control instruction input end, configured to receive the write control instruction;
a command output end, configured to send a read control command or a write control command to a corresponding SRAM group;
a read state indication signal output end, configured to output a read state indication signal to a corresponding SRAM group; and
a write state indication signal output end, configured to output a write state indication signal to a corresponding SRAM group.

18. A data access system for an SRAM array, comprising:
an SRAM array comprising a plurality of SRAM groups, each SRAM group comprising a plurality of SRAMs;
M arbitration modules, each of which is coupled with one of the M SRAM groups; and
a parsing module, coupled with the M arbitration modules and configured to receive N data access requests in parallel, parse at least one access command from each of the N data access requests, each access command being a read command or a write command and directed to one SRAM group, and send the respective access command to the arbitration module coupled with the SRAM group to which the respective access command is directed,
wherein each of the M arbitration modules is configured to: in response to a determination of receiving one access command directed to the respective SRAM group, send the one access command directed to the respective SRAM group to the respective SRAM group, so that the one access command is executed by the respective SRAM group,
wherein M is a positive integer greater than or equal to 2 and N is a positive integer.

19. The system of claim 18, wherein:
each of the arbitration modules is further configured to: in response to a determination of receiving at least two access commands directed to the respective SRAM group at a time, determine an execution order of the at least two access commands based on a predetermined arbitration strategy, and send the at least two access commands to the respective SRAM group in sequence according to the execution order, so that the at least two access commands are executed by the respective SRAM group in sequence.

20. A system on a chip, comprising the data access device for an SRAM array of claim 13.

21. A (New) system on a chip, comprising the data access device for an SRAM array of claim 14.

22. A system on a chip, comprising the data access device for an SRAM array of claim 15.

23. A system on a chip, comprising the data access device for an SRAM array of claim 16.

24. A system on a chip, comprising the data access device for an SRAM array of claim 17.

25. A system on a chip, comprising the data access system for an SRAM array of claim 18.

26. A system on a chip, comprising the data access system for an SRAM array of claim 19.

27. A data access method for an SRAM array comprising M SRAM groups, the method comprising:
receiving N data access requests;
parsing at least one access command from each of the N data access requests, each access command being a read command or a write command and directed to one SRAM group; and
for each SRAM group, performing arbitration processing comprising: in response to a determination of receiving one access command directed to the respective SRAM group, sending the one access command to the respective SRAM group, so that the one access command is executed by the respective SRAM group, wherein M is a positive integer greater than or equal to 2 and N is a positive integer.

28. The method of claim 27, wherein the performing the arbitration processing further comprises:
in response to a determination of receiving at least two access commands directed to the respective SRAM group, determining an execution order of the at least two access commands based on a predetermined arbitration strategy;
sending the at least two access commands to the respective SRAM group in sequence according to the execution order, so that the respective SRAM group executes the at least two access commands in sequence.

29. An electronic apparatus, comprising:
a memory; and
a processor,
wherein the memory has stored therein an application program executable by the processor to cause the processor to execute the data access method for an SRAM array of claim 27.

30. An electronic apparatus, comprising:
a memory; and
a processor,
wherein the memory has stored therein an application program executable by the processor to cause the processor to execute the data access method for an SRAM array of claim 28.

31. A computer-readable storage medium having stored thereon computer-readable instructions which, when executed by a processor, cause the processor to execute the data access method for an SRAM array of claim 27.

32. A computer-readable storage medium having stored thereon computer-readable instructions which, when executed by a processor, cause the processor to execute the data access method for an SRAM array of claim 28.
